(19) United States
(12) Patent Application Publication
(10) Pub. No.: US 2005/0072265 A1
(43) Pub. Date: Apr. 7, 2005

(54) Adjustable pedal assembly for exercise devices

(76) Inventor: Kerry Peters Stevens, Auckland (NZ)

Correspondence Address: CHARLES E. BAXLEY, ESQ., 90 JOHN STREET, THIRD FLOOR, NEW YORK, NY, 10038, US

(21) Appl. No.: 10/998,331

(22) Filed: Nov. 25, 2004

Related U.S. Application Data
(63) Continuation-in-part of application No. 10/402,762, filed on Mar. 28, 2003.

(51) Int. Cl. G05G 1/14

(52) U.S. Cl. 74/594.4

(57) ABSTRACT

The pedal assembly includes a pedal and a rod is movably extended through a passage defined longitudinally through the pedal. A side part is connected to one side of the peal and includes two chambers defined therein. The two chambers define two openings communicating with the passage and two a hole through an outside wall of the side part. The rod has a plurality of notches defined in one side thereof and the notches are in communication with each other. Two pins respectively and movably extend through the two holes, the two chambers and the two openings and are engaged with the notches to position the pedal relative to the rod. Each pin has a spring mounted thereto so that the pins extend into the notches when the user releases them.

### FIELD OF THE INVENTION

This is a Continuation-In-Part application of applicant's former application with application Ser. No. 10/402762, filed Mar. 28, 2003.

### BACKGROUND OF THE INVENTION

A conventional exercise device, such as an elliptical exerciser or stair climbing exerciser, includes two pedals which are respectively connected to two respective operation rods. A distal end of each of the operation rods is connected to one of two arms which can be pivoted reciprocally when the user's feet step on the two pedals. The trace of the two pedals is an oval path such that the muscles of the feet can be exercised during the operation. The pedals are made large enough so as to meet needs of different users and the larger the pedal is, the higher manufacturing cost is required. The mold for making the pedals has to be bulky and the travel of the plastic injection machine is also long, both of the two factors affect the cost of the manufacture. The number of the pedals that one process of plastic injection can produce is limited because of the size of the pedals and the cooling period is increased between two adjacent injections.

The present invention intends to provide an adjustable pedal assembly wherein the pedal can be adjusted along the rod according different needs.

### SUMMARY OF THE INVENTION

The adjustable pedal assembly for exercise devices comprises a pedal having a passage defined longitudinally therethrough and a side part is connected to one side of the peal. The side part includes two chambers defined therein and each of which defines an opening communicating with the passage and a hole through an outside wall of the side part. A rod movably extends through the passage and has a plurality of notches which are defined in one side of the rod and in communication with each other. Two pins respectively and movably extend through the two holes, the two chambers and the two openings. A first end of each of the shanks extends through the opening and is engaged with the notch aligned with the opening, a second end of the shank extends out from the hole.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pedal assembly of the present invention;

FIG. 2 is a side view to show the pedal assembly is used for an elliptical exerciser;

FIG. 3 shows a cross sectional view, taken from line A-A in FIG. 2, of the pedal assembly of the present invention;

FIG. 4 shows that the pins are pulled out from the notches in the rod so that the pedal is movable along the rod;

FIG. 5 shows that the pedal is shifted along the rod;

FIG. 6 shows the shifted pedals and the distance between the two rollers, and

FIG. 7 shows a cross sectional view, taken from line B-B in FIG. 6, of the pedal assembly of the present invention.

### DETAILED DESCRIPTION OF THE PREFERRED EMBODIMENT

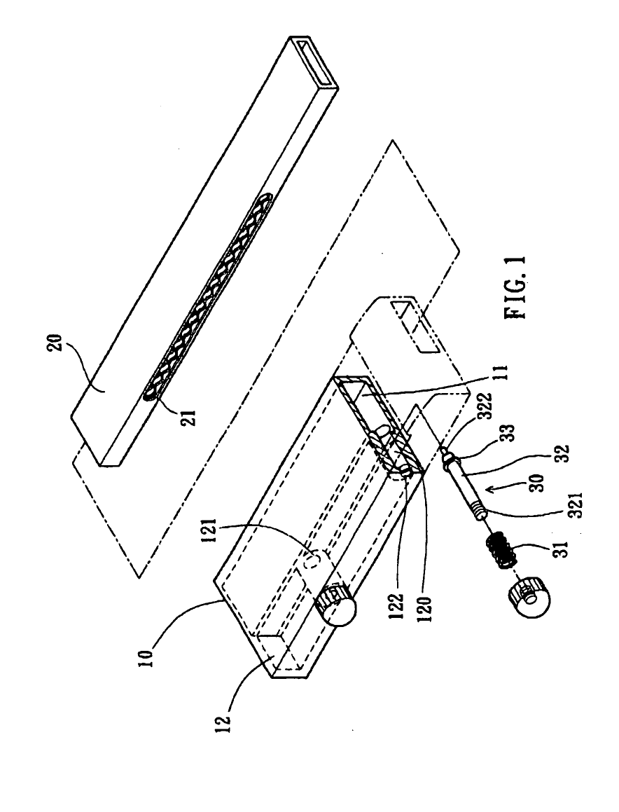

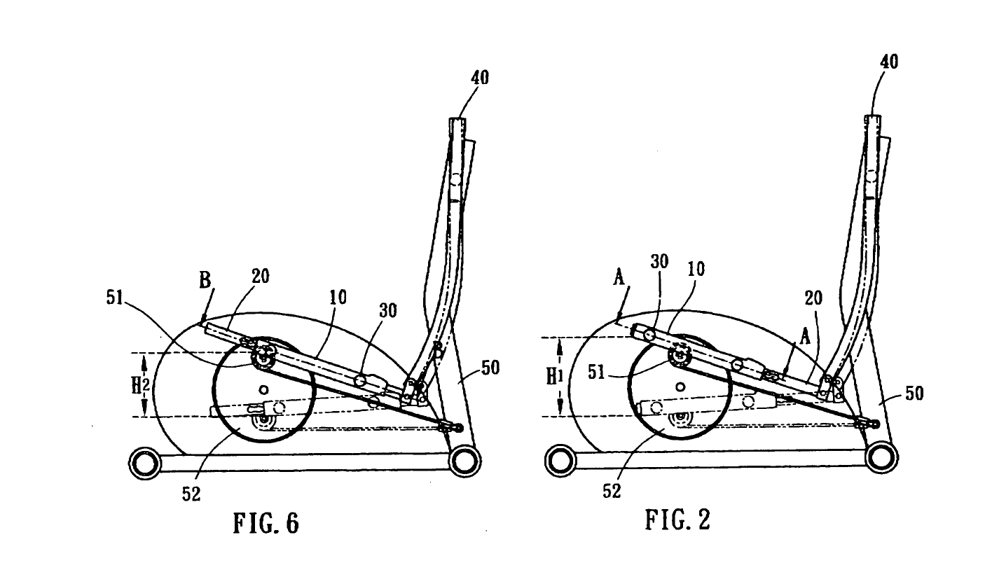

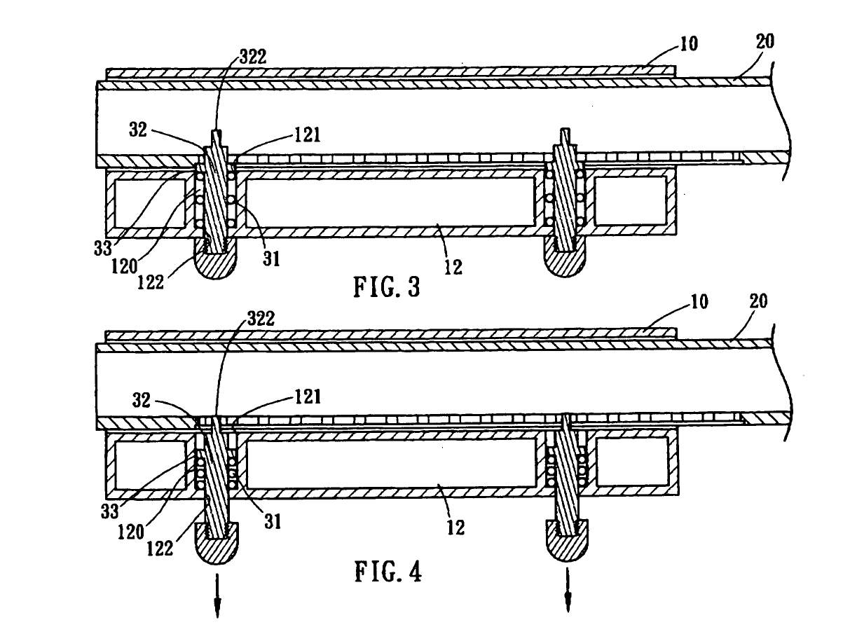

Referring to FIGS. 1 to 3, the pedal assembly for an elliptical exerciser of the present invention comprises a rectangular pedal 10 which has a rectangular passage 11 defined longitudinally therethrough and includes a flat top surface on which user's foot stands. A side part 12 is connected to one side of the peal 10 and includes two chambers 120 defined therein. The two chambers 120 define two openings 121 communicating with the passage 11 and two holes 122 through an outside wall of the side part 12.

A rectangular and hollow rod 20 slidably extends through the passage 11 and has a plurality of notches 21 which are defined in one side of the rod 20. The notches 21 are in communication with each other.

Two pins 30 respectively and movably extend through the two holes 122, the two chambers 120 and the two openings 121. A first end of each of the shanks 32 extends through the opening 121 and engages with the notch 41 aligned with the opening 121 so as to position the pedal 10 relative to the rod 20. A second end of the shank 32 extends out from the hole 122. Two springs 31 are mounted to the two shanks 32 of the pins 30 respectively and each pin 30 includes a flange 33 extending from an outer periphery thereof. The spring 31 is biased between the flange 33 and an inside of the outside wall of the side part 12. A threaded section 321 is defined in the second end of the shank 32 and a head 31 is threadedly connected to the threaded section 321. Therefore, the users conveniently grasp and pull the pins 30 away form the notches 21 when adjusting the pedals 10.

The elliptical exerciser includes two sets of the pedal 10 and the rod 20, wherein the two rods 20 are respectively connected to two arms 40 which are pivotably connected to a post 50. The two pedals 10 are movably rested on two rollers 51 on a wheel 52. By pivoting the two arms 40, the two pedals 10 are alternatively moved up and down along an elliptical trace. A distance “H1” is defined between the two respective pins 30 on the two pedals 10. Different users need different distances “H1” when operating the elliptical exerciser.

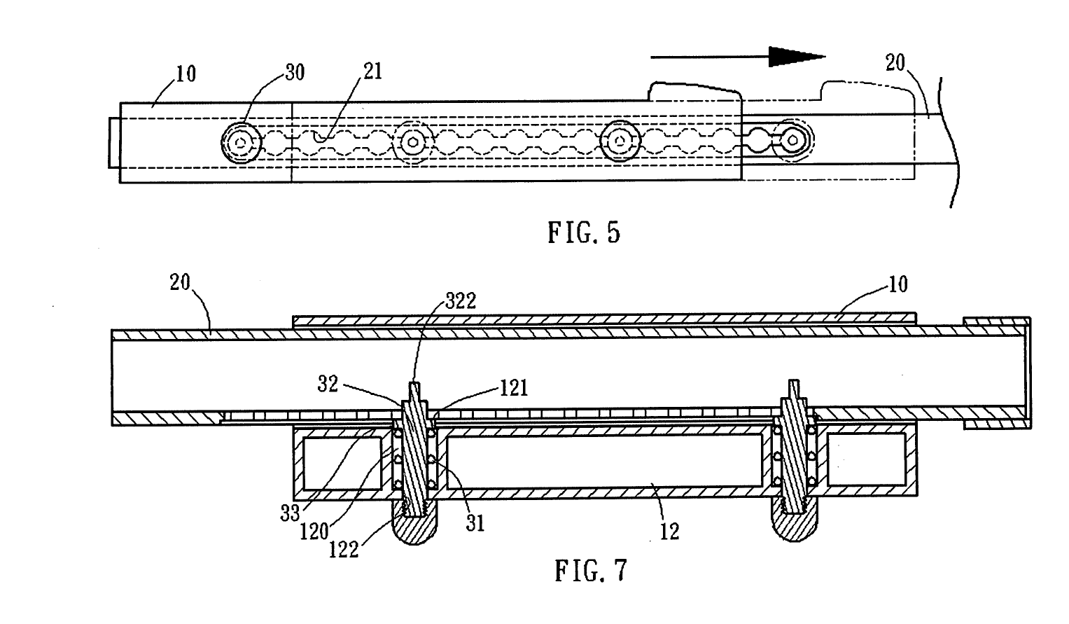

As shown in FIGS. 4 to 7, the user may easily pull the two pins 30 out from the notches 21 by compressing the springs 31, and the pedal 10 can be moved along the rod 20 till desired positions are reached. After the user releases the pins 30, the springs 31 pull the two pins 30 toward the notches 21 and the pins 30 are engaged with the notches 21 again as shown in FIG. 7. Referring to FIG. 6, by the above mentioned way, the pedals 10 can be set at a different position relative to the rods 20. The distance “H2” between the two respective pins 30 on the two pedals 10 is adjusted to be less than “H1” so as to need a shorter user's need.

It is noted that the first end of each of the shanks 32 includes a protrusion 322 extending longitudinally therefrom which includes a diameter smaller than that of the shank 32 and is received in the notch 21 when the pin 30 is pulled to disengage the shank 32 from the notch 21 as shown in FIG. 4. The protrusions 322 are sized to go through the between the communication gaps between the notches 21 and prevent the rod 20 from sliding out from the passage 11.

While we have shown and described the embodiment in accordance with the present invention, it should be clear to those skilled in the art that further embodiments may be made without departing from the scope of the present invention.

1. A pedal assembly comprising:
a pedal having a passage defined longitudinally therethrough and a side part connected to one side of the peal, the side part including two chambers defined therein, the two chambers defining two openings communicating with the passage and two holes through an outside wall of the side part;
a rod movably extending through the passage and having a plurality of notches which are defined in one side of the rod, the notches being in communication with each other, and
two pins respectively and movably extending through the two holes, the two chambers and the two openings, a first end of each of the shanks extending through the opening and engaged with the notch aligned with the opening, a second end of the shank extending out from the hole.

2. The pedal assembly as claimed in claim 1, wherein two springs are mounted to the two shanks of the pins respectively and each pin includes a flange extending from an outer periphery thereof, the spring is biased between the flange and an inside of the outside wall of the side part.

3. The pedal assembly as claimed in claim 1, wherein a threaded section is defined in the second end of the shank and a head is threadedly connected to the threaded section.

4. The pedal assembly as claimed in claim 1, wherein the first end of each of the shanks includes a protrusion extending longitudinally therefrom which includes a diameter smaller than that of the shank and is received in the notch when the pin is pulled to disengage the shank from the notch.
